(19) United States
(12) Patent Application Publication
(10) Pub. No.: US 2009/0231307 A1
(43) Pub. Date: Sep. 17, 2009

(54) DISPLAY APPARATUS FOR DISPLAYING STILL IMAGE WITH LOW POWER CONSUMPTION AND METHOD OF DISPLAYING STILL IMAGE USING THE DISPLAY APPARATUS

(75) Inventor: Moon-sang LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/173,682

(22) Filed: Jul. 15, 2008

(30) Foreign Application Priority Data
Mar. 11, 2008 (KR) 10-2008-0022594

(51) Int. Cl. G06F 3/033

(52) U.S. Cl. 345/184

(57) ABSTRACT

Provided are a display apparatus and a method of displaying a still image. The display apparatus includes: a display panel including a picture plane on which an image is displayed; an e-paper which is spread to cover the screen of the display panel when the image is no longer displayed through the display panel; and a processor which applies an electric signal to display a still image on the e-paper.

### CROSS-REFERENCE TO RELATED PATENT APPLICATION

This application claims priority from Korean Patent Application No. 10-2008-0022594, filed Mar. 11, 2008 in the Korean Intellectual Property Office, the disclosure of which is incorporated herein in its entirety by reference.

### BACKGROUND OF THE INVENTION

1. Field of the Invention

Apparatuses and methods consistent with the present invention relate to a display apparatus, and more particularly, to a display apparatus which may display a still image with low power consumption.

2. Description of the Related Art

Recently, display apparatuses such as televisions (TV), monitors and the like have been flattened and enlarged by using a liquid crystal display (LCD) panel, an organic light emitting diode (OLED) panel, a plasma display panel (PDP) or the like. However, in related art display apparatuses, when an image is no longer displayed at a display panel, the display panel changes to a simple opaque black color. This state is maintained until a signal for displaying the images again is input. In this manner, the related art display apparatuses may degrade the aesthetic appearance of places where the related art display apparatuses are installed and decrease space usability.

### SUMMARY OF THE INVENTION

The present invention provides a display apparatus which can display a still image when an image is no longer displayed at a display panel, and a method of displaying a still image by using the display apparatus.

According to an aspect of the present invention, there is provided a display apparatus including: a display panel including a picture plane on which an image is displayed; an e-paper which is spread to cover the picture plane of the display panel when the image is no longer displayed through the display panel; and a processor to apply an electric signal to display a still image on the e-paper.

The display apparatus may further include a pair of rollers which are spaced apart from each other across the display panel; a screen, both end portions of which are respectively supported by each of the rollers and including the e-paper in an area of the picture plane; and a driving means for driving the rollers, so that the e-paper covers the picture plane of the display panel when the image is no longer displayed through the display panel.

The picture plane may further include a window which is opened and corresponds to the size of the display panel in another area of the screen, and the driving means drives the rollers so as to expose the picture plane of the display panel through the window when the image is no longer displayed through the display panel.

According to another aspect of the present invention, there is provided a method of displaying a still image by using a display apparatus including a display panel having a picture plane on which an image is displayed and e-paper being spread so as to cover the picture plane of the display panel, the method including: spreading the e-paper to cover the picture plane of the display panel when the image is no longer displayed through the display panel; and displaying the still image through the e-paper.

The method of displaying the still image may further include removing the e-paper from the picture plane so as to expose the picture plane of the display panel when the image is displayed again through the display panel.

According to an aspect of the present invention, the displaying of the still image may include sequentially displaying a plurality of still images at predetermined intervals of time.

According to an aspect of the present invention, still image contents which can be displayed through the e-paper may be input to the display apparatus from another electronic device connected to the display apparatus.

According to an aspect of the present invention, still image contents which can be displayed through the e-paper may be input to the display apparatus through an Internet.

### BRIEF DESCRIPTION OF THE DRAWINGS

The above and other aspects of the present invention will become more apparent by describing in detail exemplary embodiments thereof with reference to the attached drawings in which:

FIG. 1 is a perspective view illustrating a display apparatus according to an exemplary embodiment of the present invention;

FIG. 2 is a schematic block diagram of a display apparatus according to an exemplary embodiment of the present invention;

FIG. 3 is a plan view illustrating a screen according to an exemplary embodiment of the present invention;

FIG. 4A is a cross-sectional view illustrating a display apparatus according to an exemplary embodiment of the present invention, when a display panel is turned-on; and

FIG. 4B is a cross-sectional view illustrating a display apparatus according to an exemplary embodiment of the present invention when a display panel is turned-off.

### DETAILED DESCRIPTION OF EXEMPLARY EMBODIMENTS

Exemplary embodiments of the invention will now be described more fully with reference to the accompanying drawings.

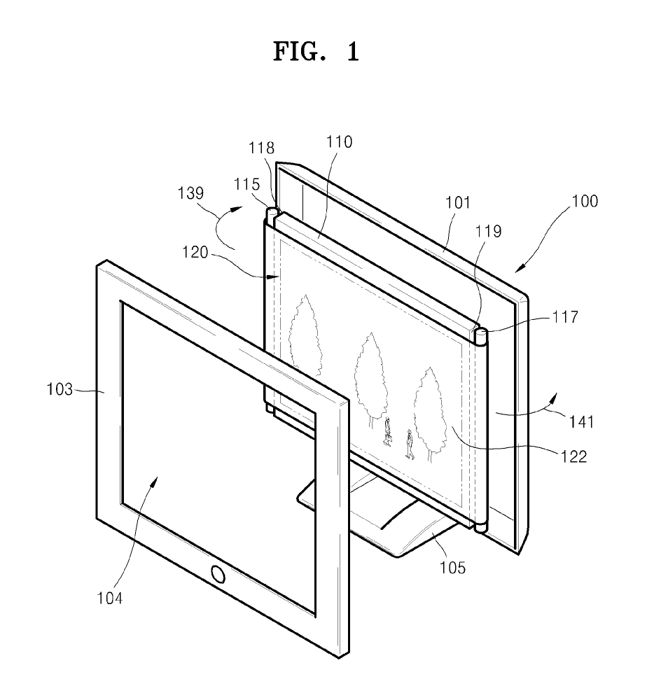

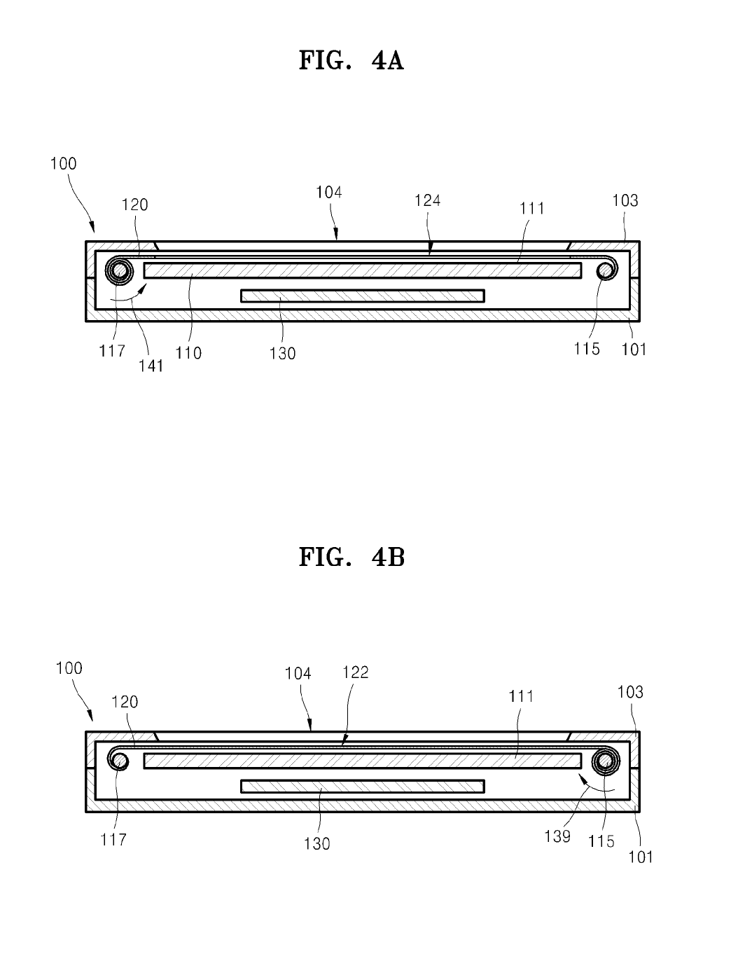

Referring to FIG. 1, a display apparatus 100 according to an exemplary embodiment of the present invention includes a housing including a rear case 101 and a front case 103 coupled with the rear case 101, a supporter 105 which supports the housing, a display panel 110 including a picture plane 111 (see FIG. 4A) which displays an image and disposed in the housing, a first roller 115 and a second roller 117 which are disposed so as to be spaced from each other across the display panel 110, and a screen 120. First and second end portions 118 and 119 of the screen 120 are supported by the first and second rollers 115 and 117.

The display panel 110 may be a flat display panel, such as an LCD panel, a PDP, a field emission display (FED) panel, or an OLED panel. However, the present invention is not limited thereto. A window 104, which is open to expose the picture plane 111 of the display panel 110, is formed in the front case 103.

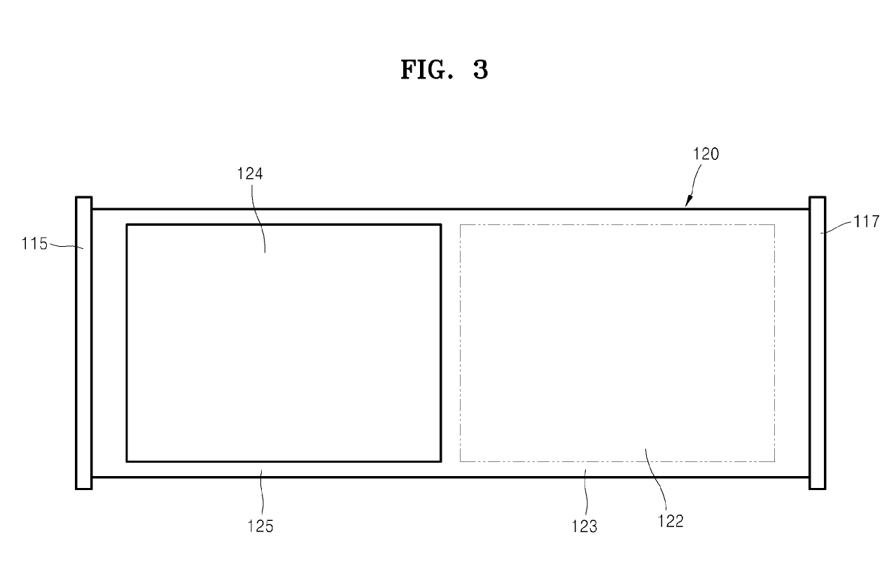

Referring to FIG. 3, the screen 120 includes an e-paper 122 formed in a first area 123 of the screen 120 to correspond to a size of the picture plane 111, and a window 124 formed in a second area 125 of the screen 120 to be opened and correspond to the size of the picture plane 111. The e-paper 122 has a reaction speed which is slower than that of the flat display panel, such as the LCD panel, the PDP, the OLED panel, or the FED panel, and thus is insufficient to display a moving image. However, the e-paper 122 is inexpensive and simple, and may be folded or rolled. The e-paper 122 consumes power only when an image displayed on the e-paper 122 is changed, and does not consume power while a still image is being maintained. Therefore, the e-paper 122 may display the still image with low power consumption as compared to when the still image is displayed through the flat display panels, such as an LCD panel, a PDP, an OLED panel, or a FED panel.

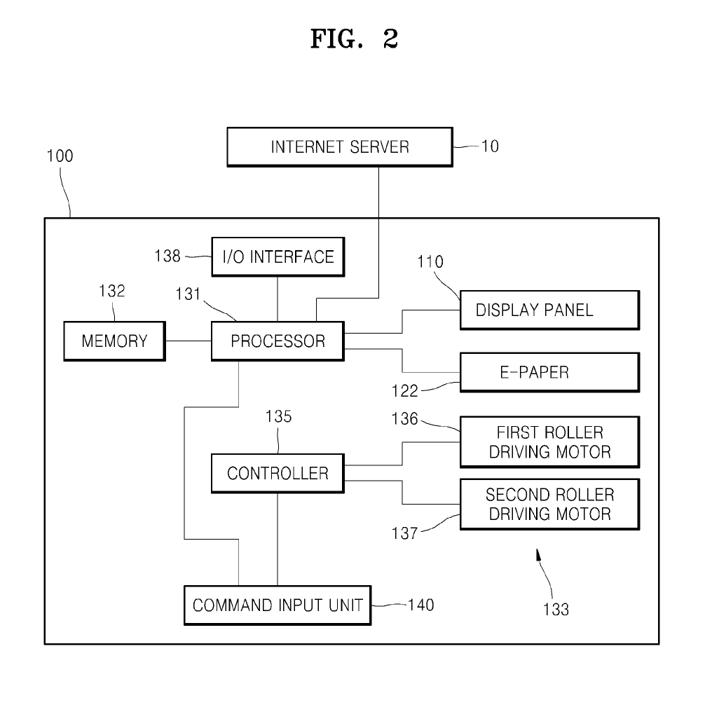

The display apparatus 100 includes a driving unit 133 for driving the rollers 115 and 117. Referring to FIGS. 1 and 2, the driving unit 133 includes a first roller driving motor 136 which provides driving power to the first roller 115, a second roller driving motor 137 provides driving power to the second roller 117, and a controller 135 controls the first and second roller driving motors 136 and 137. Although not shown in the drawing, gears may be formed in an end portion of the first and second rollers 115 and 117 to receive power from the first and second roller driving motors 136 and 137.

When an image is no longer displayed through the display panel 110, the controller 135 controls transmission of revolving power of the first roller driving motor 136 to the first roller 115, and thus the first roller 115 revolves clockwise in a first direction 139. The controller 135 controls separation of the second roller 117 from the second roller driving motor 137, and thus the second roller 117 enters an idle state. The screen 120 is rolled onto the first roller 115, and as a result, the e-paper 122 is overlapped with the picture plane 111 as shown in FIG. 4B. When the picture plane 111 is covered by the e-paper 122, the controller 135 controls the first roller driving motor 136 to stop, and the screen 120 is pulled to maintain a proper tension.

When an image is displayed again through the display panel 110, the controller 135 controls transmission of revolving power of the second roller driving motor 137 to the second roller 117, and the separation of the first roller 115 from the first roller driving motor 136. The second roller 117 revolves counterclockwise in a second direction 141, while the first roller 115 enters an idle state. The screen 120 is rolled into the second roller 117, and the window 124 of the screen 120 is overlapped with the picture plane 111 as shown in FIG. 4A. When the picture plane 111 is exposed by the window 124, the controller 135 controls the second roller driving motor 137 to stop. The screen 120 is pulled to maintain a proper tension. However, the described driving means 133 is an example of a driving means for driving the rollers 135 and 137. For example, the rollers 135 and 137 may be driven by only one driving motor or any other appropriate means.

The display apparatus 100 includes a processor 131 which applies proper electric signals to display images on the display panel 110 and the e-paper 122, a memory 132 which stores software and data which are used in a processing operation for displaying an image, a command input unit 140 which inputs various user commands including the performing of ON/OFF operations of the display panel 110, and an input/output (I/O) interface 138 which connects the display apparatus 100 to other electronic devices, such as a portable memory card. The processor 131, the memory 132, the controller 135, the command input unit 140, and the I/O interface 138 may be realized via various electronic devices mounted on a circuit board 130 (see FIGS. 4A and 4B) in the housing and a circuit pattern formed on the circuit board 130.

Hereinafter, a method of displaying a still image by using the display apparatus 100 will be described. When a command for an image display is input to the processor 131 from the command input unit 140, the processor 131 applies an appropriate electric signal to the display panel 110 to display an image on the picture plane 111 of the display panel 110. At this point, as shown in FIG. 4A, the window 124 of the screen 120 is overlapped with the picture plane 111, thereby exposing the picture plane 111. When a user inputs a command to stop the image being displayed by operating the command input unit 140, the controller 135 controls the second roller 117 to enter an idle state and the first roller 115 to revolve clockwise in the first direction 139 so that the e-paper 122 of the screen 120 is overlapped with the picture plane 111 and covers the picture plane 111. Since revolution of the first roller 115 and movement of the screen 120 are performed as described above, a repeated description thereof will be omitted.

When the command, received from the command input unit 140, to stop the image display is transmitted to the processor 131, the processor 131 stops applying an electric signal to the display panel 110 and applies an electric signal corresponding to a still image to the e-paper 122. Thus, the still image, which can be seen by a user, is displayed on the e-paper 122, as shown in FIG. 1.

The electric signal for displaying the still image on the e-paper 122 is only applied once after the e-paper 122 is spread, and the electric signal is not applied to the e-paper 122 while the same still image is maintained. However, a plurality of still images may be sequentially displayed on the e-paper 122, which is spread in front of the display panel 110, at predetermined intervals of time. In this case, whenever the still image is changed, an electric signal corresponding to a still image is applied to the e-paper 122, and an electric signal is not applied to the e-paper 122 while the particular still image is maintained.

When a user inputs a command to restart an image display by operating the command input unit 140, the first roller 115 enters an idle state and the second roller 117 revolves counterclockwise in the second direction 141 under the control of the controller 135 so that the window 124 of the screen 120 is overlapped with the picture plane 111 to expose the picture plane 111, as shown in FIG. 4A. Since revolution of the second roller 117 and movement of the screen 120 are performed as described above, a repeated description thereof will be omitted.

When command to restart the image display through the command input unit 140 is transmitted to the processor 131, the processor 131 applies an electric signal for an image display to the display panel 110. Accordingly, the image is displayed on the picture plane 111 of the display panel 110.

Stopping display of an image through the display panel 110 is not performed only according to a command received by the command input unit 140. The image display may be stopped by directly inputting a command to stop an image being displayed to the display panel 110 or by stopping the application of an electric signal to the display panel 110 according to a determination that the electric signal applied to the display panel 110 does not flow smoothly. In accord with an exemplary embodiment, when the image is no longer displayed through the display panel 110 due to various reasons, the processor 131 applies an electric signal corresponding to a still image to the e-paper 122 and controls the display apparatus 100 to display the still image as described above.

Still image contents which can be displayed on the e-paper 122, may be input to the memory 132 from another electronic device connected via an I/O interface 138 and stored in the memory 132. Also, the still image contents may be consciously or unconsciously input and stored in the memory 132 through the Internet via an Internet server 10. For example, a user may consciously download the still image contents stored in an Internet server 10 to the display apparatus 100 by accessing a website, or the still image contents and Internet protocol TV contents may be automatically input together in the display apparatus 100 while the user is watching the Internet protocol television (IPTV) through the display apparatus 100. For example, contents, such as an advertisement or a notification, may include still image contents which are automatically input together with the IPTV contents.

When an image is no longer displayed through the display panel 110, the still image contents stored in the memory 132 may be sequentially displayed on the e-paper 122, according to a predetermined order and intervals of time by a default setting determined by software installed in the display apparatus 100. On the other hand, a user may display only desired still image contents on the e-paper 122 or may filter undesired still image contents, so that the undesired still image contents are not displayed, by canceling the default setting of the software and changing the default setting by himself/herself.

According to a display apparatus and a method of displaying a still image using the display apparatus of the exemplary embodiments, even when an image is no longer displayed through a display panel, the still image may be displayed in the same area of the screen, and thus, the display apparatus can improve the beauty of places where the display apparatus is installed and increase space usability.

Also, e-paper needs power only when an image displayed is changed, and extra power is unnecessary while the same still image is maintained. Thus, the display apparatus may display a still image with lower power consumption compared to when the still image is displayed through a display panel.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A display apparatus comprising:
a display panel comprising a picture plane on which an image is displayed;
an e-paper which is spread so as to cover the picture plane of the display panel when the image is no longer displayed through the display panel; and
a processor which applies an electric signal to display a still image on the e-paper.

2. The display apparatus of claim 1, further comprising:
first and second rollers which are disposed on opposite sides of the display panel;
a screen comprising first and second end portions which are supported by the first and second rollers, respectively, wherein the e-paper is disposed in a first area of the screen; and
driving means for driving the first and second rollers to spread the e-paper to cover the picture plane of the display panel when the image is no longer displayed through the display panel.

3. The display apparatus of claim 2, wherein the screen further comprises:
a window which is opened and corresponds to a size of the picture plane of the display panel in a second area of the screen,
wherein the driving means drives the first and second rollers to expose the picture plane of the display panel through the opened window when the image is displayed via the display panel.

4. A method of displaying a still image by using a display apparatus comprising a display panel having a picture plane on which an image is displayed, the method comprising:
spreading an e-paper to cover the picture plane of the display panel when the image is no longer displayed through the display panel; and
displaying the still image via the e-paper.

5. The method of claim 4, further comprising:
removing the e-paper from the picture plane to expose the picture plane of the display panel when the image is displayed through the display panel.

6. The method of claim 4, wherein the displaying of the still image comprises:
sequentially displaying a plurality of still images at predetermined intervals of time.

7. The method of claim 4, further comprising:
receiving still image contents from another electronic device connected to the display apparatus; and
displaying the received still image contents on the e-paper.

8. The method of claim 4, further comprising:
receiving still image contents through an Internet; and
displaying the received still image contents on the e-paper.
